(19) United States
(12) Patent Application Publication
(10) Pub. No.: US 2006/0083112 A1
(43) Pub. Date: Apr. 20, 2006

(54) Apparatus for multiple alerts

(75) Inventors: Wong Hoo Sim, Singapore (SG); Seng Chong Goh, Melaka (MY)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 10/961,167

(22) Filed: Oct. 8, 2004

(51) Int. Cl. G04B 47/00; G08B 1/00

(52) U.S. Cl. 368/10; 340/309.16

(57) ABSTRACT

A portable apparatus for multiple alerts, the apparatus comprising a processor operatively connected to a display, at least one input for enabling alert times to be determined by a user, an alert output, and a clock system for providing the multiple alerts. Each alert is at a different time. The multiple alerts are output by the alert output to alert a user as to at least one action required by the user. The alert output may be an audible alert, a visual alert on a display of the apparatus, and/or a vibrating alert. The multiple alerts are at times that are from a predetermined list, pre-set, or by user input.

### FIELD OF THE INVENTION

This invention relates to apparatus for multiple alerts and refers particularly, though not exclusively, for such an apparatus for alerting a person of time for taking an action such as, for example, prayers or taking medication.

### BACKGROUND OF THE INVENTION

Devout Muslims pray five times a day at set times. Although some flexibility is allowed, in general the times are fixed. Also, the necessary ablutions must be performed before each prayer session. These ablutions may take varying times depending on the person occupation, location, the conditions at that location, and the person state of cleanliness.

It is difficult for the prayer times to be observed in for a busy person, particularly when travelling.

A similar situation is faced by those who must take medication several times a day at prescribed intervals; and by those who are followers of other religious such as, for example, Christianity and Buddhism.

### SUMMARY OF THE INVENTION

In accordance with a first aspect there is provided portable apparatus for multiple alerts, the apparatus comprising a processor operatively connected to a display, an alert input for enabling alert times to be determined by a user, an alert output, and a clock system for providing a plurality of alerts. Each alert is at a different time. The alerts are output by the alert output to alert a user of at least one action required by the user.

In accordance with a second aspect there is provided portable apparatus for multiple alerts, the apparatus comprising a processor operatively connected to a display, at least one input for enabling alert times to be determined by a user, an alert output, and a clock system for providing a plurality of alerts. The clock system able to be automatically reset according to time zones by user of the at least one input.

The alert output may comprise at least one of: an audible alert, a visual alert on a display of the apparatus, and a vibrating alert. The plurality of alerts may be at times selected from: a predetermined list, pre-set and user input. The times may be a period before a required action is to be undertaken, the period being one of: preset, selected from a list of options, input by a user.

The at least one input may be provided for entering of data relating to at least one of: time, time zone, and alert times.

The at least one input may be at least one selected from: a keypad of the portable apparatus, control buttons of the portable apparatus, and from a computer to which the portable apparatus is operatively connected.

The apparatus may further comprise a GSM module for providing position information for the apparatus. The position information may be used to determine at least one of: a direction of travel of the device, the time zone in which the apparatus is located, a direction to Mecca. The time zone may be used to automatically amend a time of the clock system, and with it the alert times.

The alert may include a message, the message being at least one of: preset, selected from a preset list, and user input using an input system. The input system may be one of: the at least one input, a keypad, a microphone, and a separate computer. The message may be stored in a non-volatile memory of the apparatus.

The apparatus may be a mobile audio player. The number of alerts may be in the range of three to ten, preferably five. The message may be different for each of the multiple alerts.

The apparatus may be a portable media player and audio may be stored in a non-volatile memory of the portable media player for reproduction when the user is taking the at least one action.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings in which:

FIG. 1 is a perspective view of an embodiment of the device; and

FIG. 2 is a block diagram of the device of FIG. 1.

### DETAILED DESCRIPTION OF THE PREFERRED EMBODIMENTS

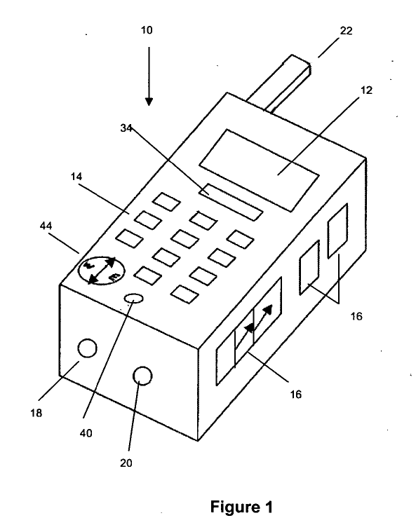

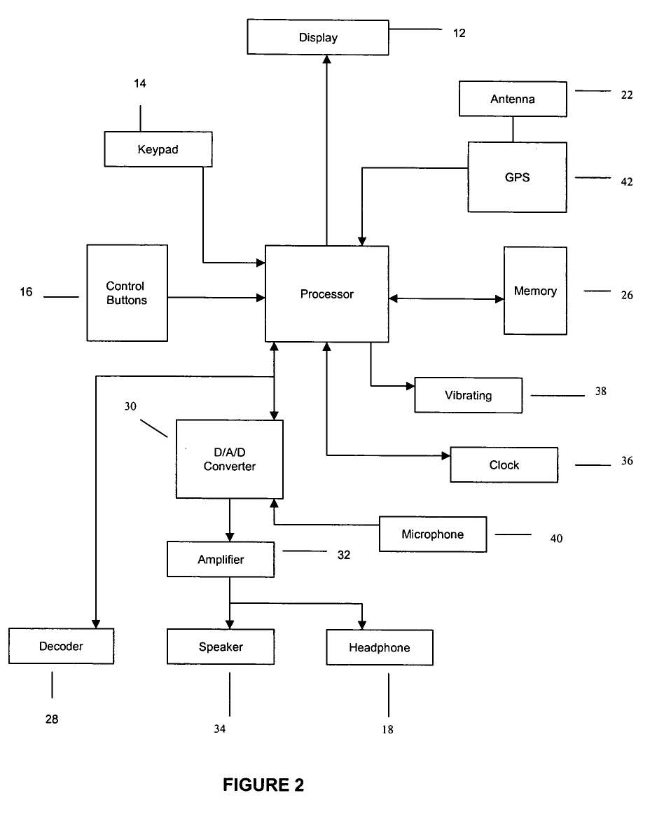

FIGS. 1 and 2 show a portable device 10 that may be dedicated device, a portable audio player, a mobile telephone, or otherwise as required or desired. As shown, it is a portable audio player such as, for example, an MP3 player.

The portable device 10 has a display 12, operational control buttons 16, a headphone connection socket 18, and a battery recharging connection 20. The portable device 10 may also have an antenna 22 and keypad 14.

The device 10 has a main processor 24 that is operatively connected to the display 12, and control buttons 16. The main processor 24 may be a microprocessor and/or digital signal processor. There is also a non-volatile memory 26 such as, for example, flash memory or a disk drive. If a keypad 14 is provided it will also be operatively connected to main processor 24.

If device 10 is an audio player, it will include audio circuitry including a decoder 28, a digital/analog converter 30, an amplifier 32, and the headphone socket 18. It may also include a speaker 34.

The device 10 also includes a clock system 36. Control buttons 16 may be used to set the clock-system 16, and to enter alert times for required functions. If keypad 14 is provided, it may be used to set the clock system 36 and to enter alert times for required functions. Required functions may be events, such as, for example, prayers or taking medication. Alternatively, if keypad 14 is not provided, device 10 may be operatively connected to a computer by a wired or a wireless connection, and the computer used to set the clock system, to enter alert times, and/or to download audio to device 10. The number of alert times able to be set may be limited, preset, or variable. It may be in the range of 3 to 10, preferably 5. For example, a Muslim may need 5 alerts per day (a day being 24 hours) for prayers; but a patient may need up to 8 or 10 alerts a day for medication. Alert times may also be entered by selecting times from one or more menus on display 12.

Alerts may be an audio alert using speaker 34 and/or a vibrating alert using vibration module 38, in the known manner for mobile telephones. A message may also be displayed on display 12. The messages may be stored in memory 26 and may be different messages for each alert. Messages may be pre-set, or may be able to be entered using keypad 14 or as a voice recording using microphone 40. Alerts may be scheduled as required by a user, and may be for the actual time required, or may be for a period before the actual time required. The period before may be user set or pre-set.

As an option, a GPS receiver module 42 may be provided, together with the antenna 22. In this way the position of device 10 may be known. As the various time zones of the world are fixed, and the “summer time” changes are regular and know for each country, and state within a country, the clock may be automatically reset to the correct local time whenever travelling and crossing from one time zone into another time zone. Alternatively, the activation of the GPS module may be user initiated so that it is only done upon user request. This will be particularly relevant for aircraft travel. Any alerts will be automatically changed with the change in time zone.

Alternatively, or additionally, upon a user inputting the relevant time zone information using control buttons 16, or keypad 14, the clock 36 (and all entered alerts) will be reset. Alternatively, the time zone may be selected from a list on display 12 using keypad 14, control buttons 16 or when device 10 is operatively connected to a computer.

The alerts may be user entered using keypad 14 and/or may be selected from a list on display 12 using keypad 14, control buttons 16 or when device 10 is operatively connected to a computer. For example, the list may include the standard Muslim prayer times, a period before the standard Muslim prayer time (the period being preset or from user input) or by user input using keypad 14, or by selection from a list on display 12; medication times; Christian prayer times; and so forth. The period before would normally be a few minutes up to several minutes—a period in which a person could undertake the required action including locating Mecca, conducting ablutions, finding medication, and so forth.

Furthermore, a compass 44 may be provided to assist a Muslim in determining the direction of Mecca. Alternatively, if the GPS module 42 is used, the direction of travel of device may be plotted, and the direction of Mecca from the then location of device 10 displayed on display 12. The direction of travel may be determined from sequential GPS readings.

Also, if device 10 is an audio player, relevant music chants, prayers, hymns, psalms, readings from religious or like texts, messages, sounds, or other audio tracks, may be recorded and stored in memory 26 for playback at the relevant time. These may be pre-recorded, or download and stored in memory 26 by a user. There may be a link to the alert so that at the required time the relevant audio tracks are selected and replayed. This may be by use of headphone socket 18 and headphones or speakers connected thereto.

Whilst there has been described in the foregoing description preferred embodiments of the present invention, it will be understood by those skilled in the technology concerned that many variations or modifications in details of design or construction may be made without departing from the present invention.

1. A portable apparatus for multiple alerts, the apparatus comprising:
(a) a processor operatively connected to a display;
(b) at least one input for enabling alert times to be determined by a user;
(c) an alert output; and
(d) a clock system for providing the multiple alerts, each alert being at a different time, the multiple alerts being output by the alert output to alert a user as to at least one action required by the user.

2. Apparatus for multiple alerts, the apparatus comprising:
(a) a processor operatively connected to a display;
(b) at least one input for enabling alert times to be determined by a user;
(c) an alert output; and
(d) a clock system for providing a plurality of alerts, the clock system being able to be automatically reset according to time zones by use of the at least one input.

3. Apparatus as claimed in claim 1, wherein the alert output comprises at least one selected from the group consisting of: an audible alert, a visual alert on a display of the apparatus, and a vibrating alert.

4. Apparatus as claimed in claim 2, wherein the alert output comprises at least one selected from the group consisting of: an audible alert, a visual alert on a display of the apparatus, and a vibrating alert.

5. Apparatus as claimed in claim 1, wherein the multiple alerts are at times selected from the group consisting of: a predetermined list, pre-set and user input.

6. Apparatus as claimed in claim 2, wherein the multiple alerts are at times selected from the group consisting of: a predetermined list, and user input.

7. Apparatus as claimed in claim 5, wherein the times are period before the action is to be undertaken, the period being one of: preset, selected from a list of options, input by a user.

8. Apparatus as claimed in claim 1, wherein the at least one input is for entering of data relating to at least one of: time, time zone, and alert times.

9. Apparatus as claimed in claim 2, wherein the at least one input is for entering of data relating to at least one of: time, time zone, and alert times.

10. Apparatus as claimed in claim 1, further comprising a GSM module for providing position information for the apparatus, the position information being used to determine at least one of: a direction of travel of the device, and the time zone in which the apparatus is located.

11. Apparatus as claimed in claim 10, wherein the time zone is used to automatically amend a time of the clock system, and the alert times.

12. Apparatus as claimed in claim 8, wherein the time zone is used to amend a time of the clock system, and the alert times.

13. Apparatus as claimed in claim 1, wherein the alert includes a message, the message being at least one of: preset, selected from a preset list, and user input using an input system.

14. Apparatus as claimed in claim 13, wherein the message is different for each of the multiple alerts.

15. Apparatus as claimed in claim 13, wherein the input system is one of: the at least one input, a microphone, a keypad, a separate computer.

16. Apparatus as claimed in claim 14, wherein the message is stored in a non-volatile memory of the apparatus.

17. Apparatus as claimed in claim 1, wherein the number of alerts is in the range of 3 to 10.

18. Apparatus as claimed in claim 1, wherein the number of alerts is five.

19. Apparatus as claimed in claim 1, further comprising a compass.

20. Apparatus as claimed in claim 1, wherein the apparatus is a portable media player.

21. Apparatus as claimed in claim 20, wherein audio is stored in a non-volatile memory of the portable media player for reproduction when the user is taking the at least one action.
